(19) United States
(12) Patent Application Publication
(10) Pub. No.: US 2004/0015394 A1
(43) Pub. Date: Jan. 22, 2004

(54) Method for rewarding customer loyalty with respect to a lease agreement

(76) Inventors: Beatrice Mok, Robinson Mansion (HK); Edwin Wah Sing Mok, Sidney (AU)

Correspondence Address: GARDNER CARTON & DOUGLAS LLP, 191 N. WACKER DRIVE, SUITE 3700, CHICAGO, IL, 60606, US

(21) Appl. No.: 10/198,887

(22) Filed: Jul. 19, 2002

(51) Int. Cl. G06F 17/60

(52) U.S. Cl. 705/14

(57) ABSTRACT

The invention involves a method for rewarding customer loyalty with respect to a lease agreement. The inventive method is comprised of the steps of: (a) identifying a starting date; (b) establishing at least one reward date; (c) determining if provisions of the lease agreement have been performed as of the at least one reward date; and (e) calculating a reward of a specific value that may increase exponentially from a first reward date to a second reward date.

### FIELD OF THE INVENTION

This invention relates generally to customer-reward programs and, more particularly, to a reward program for tenants, lessees and/or occupants of a rental property.

### BACKGROUND OF THE INVENTION

Programs for rewarding customer loyalty are well known. Probably the best known of customer-reward programs are the frequent-flyer awards given by most, if not all, airlines to help establish brand loyalty. Other customer-reward programs have involved the awarding of coupons or trading stamps that can be redeemed for certain items of merchandise. Another reward program disclosed in U.S. Pat No. 5,991,736 (Ferguson et al.) involves a patronage incentive program that transfers money to a customer's retirement account to reward them for purchasing particular products from certain program sponsors.

Reward programs that involve real estate are also known. U.S. Pat. No. 6,226,621 (Warsh) is directed to a system for administering an awards program for an apartment, office, retail or industrial property that is divided into units or spaces. According to the system disclosed in the Warsh patent, an award is provided to a person living in or working on the property if that person's actions result in a new resident or tenant. The award in the Warsh patent varies depending on the level of occupancy of the property in question.

No reward program exists, however, that rewards a tenant, lessee or occupant for remaining in a lease beyond a set period of time. Such an incentive program is useful, for example, in certain geographical areas where tenants or occupants move out of rental units at the end of a tourist season. By vacating a particular property, the occupants or tenants place a burden on landlords because it may take 3 to 4 months before a new tenant or occupant can be found. This causes a landlord to forgo several months worth of rent as there is no incentive to cause a tenant or an occupant to remain in a rental unit following, for example, the close of a tourist season.

A reward program that would reward a tenant, lessee, or occupant of a rental property who remains in the property beyond a particular reward date would be an important improvement in the art. Furthermore, a reward program that would also reward a tenant, lessee, or occupant for recommending a new tenant, lessee or occupant, or would reward a tenant, lessee or occupant for prompt payment of rent would also be an improvement in the art. Finally, a reward program that provided an escalating reward to a tenant, lessee, or occupant who remained in a rental property beyond a first reward date would be an advancement in the area of rewarding customer loyalty.

### SUMMARY OF THE INVENTION

The invention involves a method for rewarding customer loyalty with respect to a lease agreement. The inventive method is comprised of the steps of: (a) identifying a starting date; (b) establishing at least one reward date; (c) determining if provisions of the lease agreement have been performed as of the at least one reward date; and (e) calculating a reward of a specific value.

In one embodiment, the invention also involves a data processing system for managing a customer-loyalty-reward program with respect to a lease agreement. The data processing system is comprised of a reward-calculation component for calculating a reward of a specific value based on a starting date and at least one specific reward date. The reward calculation component is also capable of calculating a reward based on: (1) the number of new customers referred to a lessor by an existing customer, and (2) the customer's prompt payment of lease payments.

In still another embodiment the invention involves a computer-readable medium having computer-executable instructions for performing a method comprising: (a) assigning a form of identification to a customer; (b) establishing a reward account for the customer based on the identification assigned; (c) identifying a starting date; (d) determining at least one reward date; (e) calculating a reward of a specific value; and (f) depositing the calculated reward into the customer's reward account.

### BRIEF DESCRIPTION OF THE DRAWINGS

FIG. 1 is a flow diagram showing the steps involved in calculating a reward of a specific value in accordance with one embodiment of the invention.

FIG. 2 is a flow diagram showing the steps involved in calculating a reward of a specific value in accordance with a second embodiment of the invention.

FIG. 3 is a schematic diagram showing a computer network connection similar to the type that may be used with the invention.

### DETAILED DESCRIPTION OF THE INVENTION

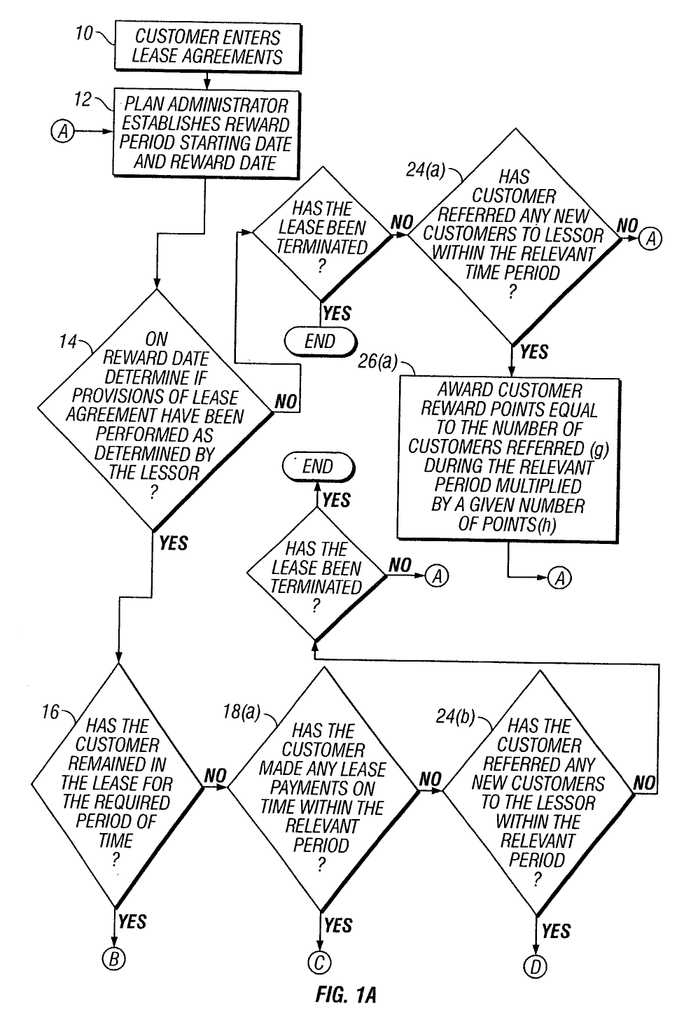

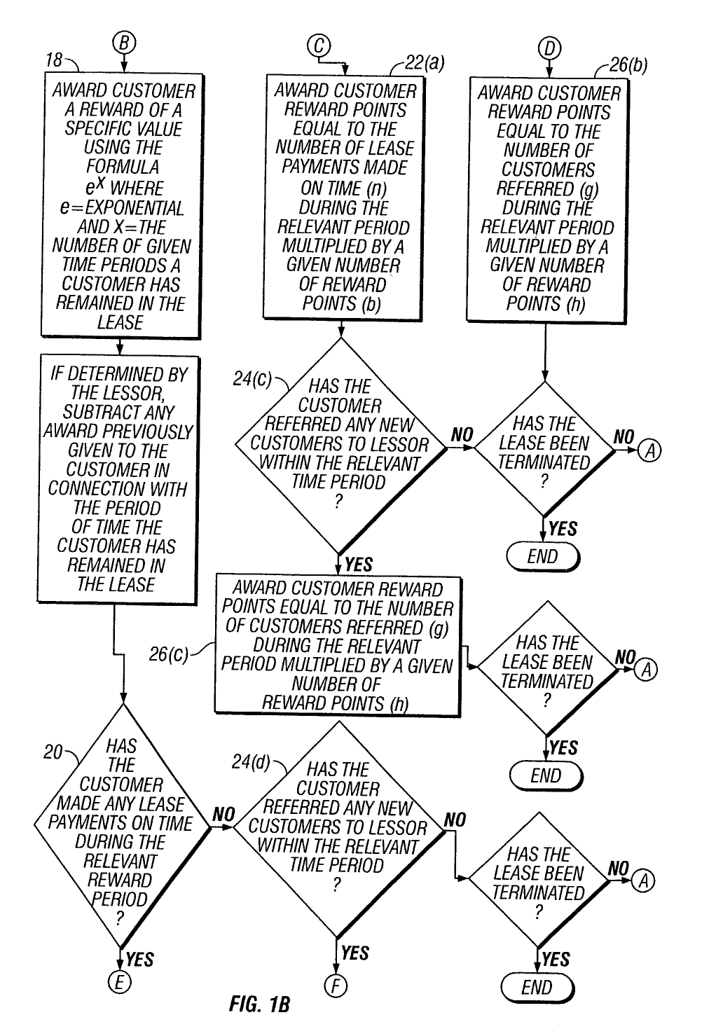

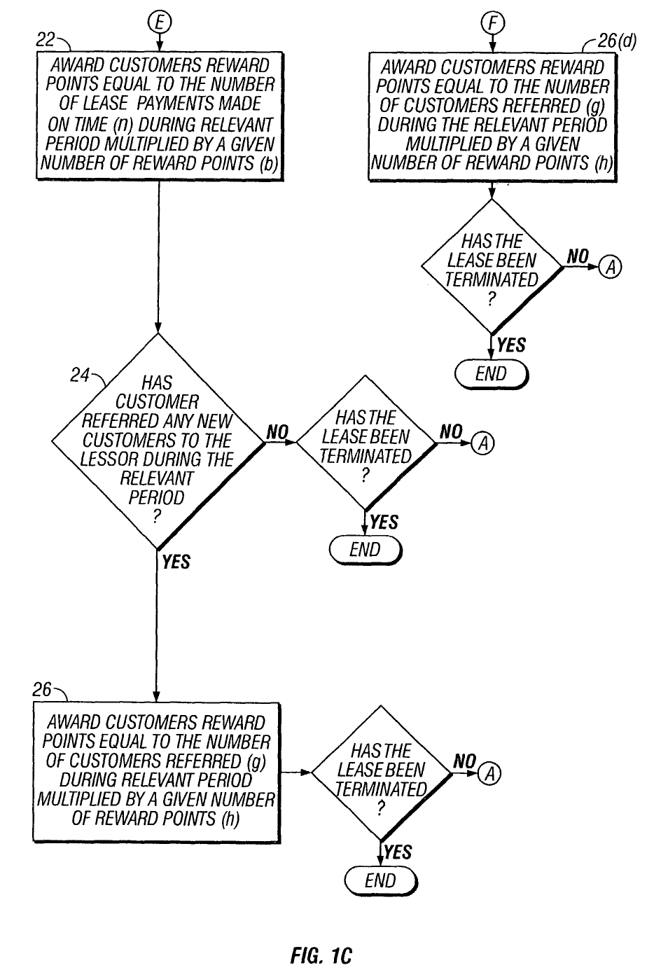

The invention involves a method for rewarding customer loyalty with respect to a lease agreement. As shown in FIGS. 1(A-C) and 2(A-C), once a customer enters a lease agreement 10, the inventive method is comprised of the steps of: (a) identifying a starting date and at least one reward date 12; (b) determining if provisions of the lease agreement have been performed as of the at least one reward date 14; and (c) calculating a reward of a specific value 16. In one embodiment of the invention, the starting date is the date on which a customer entered into the lease agreement. In another embodiment of the invention, the starting date is the date on which the customer is given possession of or occupies a rental property or unit that is the subject of the lease agreement. For purposes of this invention, a customer may include a lessee, a tenant, or an occupier of the rental property.

The inventive method may also comprise the additional steps of assigning a form of identification to the customer, establishing a reward account for the customer based on the identification assigned and depositing the calculated reward into the customer's reward account.

In addition to having a singular reward date, another embodiment of the invention calls for calculating a series of rewards to be awarded on different award dates. In this embodiment, the method is further comprised of the steps of determining a series of reward dates and calculating a series of rewards, each reward in the series being of a specific value based on an amount of time that has elapsed from the starting date to a particular reward date in the series of reward dates.

The reward may be anything of value without departing from the scope of the invention. It is anticipated, however, that typical rewards will include, among other things, airline frequent-flyer miles, points redeemable for discounts or credits at various restaurants, retail outlets, hotels, holiday resorts, package tours, other entertainment establishments or the like. The reward may also be in the form of a discount card that provides discounts, gifts or services at a plurality of merchants.

In another embodiment of the invention, a customer is rewarded for making lease payments on time or ahead of their due dates 18. In this embodiment, the method is further comprised of the steps of: (1) setting up a series of lease payments in relation to the customer; (2) establishing a series of lease-payment dates at a given interval on which at least one lease payment in the series of lease payments is due; (3) collecting at least one of the lease payments on a date no later than at least one of the lease-payment dates in the series; (4) determining if there is at least one unpaid lease payment due prior to the date of collecting the at least one lease payment; and (5) awarding a reward of a specific value to the customer if there is no at least one unpaid lease payment due prior to the date of collecting the at least one lease payment.

The inventive method applies to any rental property or item, but most particularly, to real estate.

Although in one of the most common embodiment, the reward date will be a date subsequent to the start date and the specific value of the reward will be calculated based on an amount of time that has elapsed from the starting date to the at least one reward date, nothing in the invention is to be construed as prohibiting the reward date from being the same date as the start date. Furthermore, the specific value of the reward may also be calculated based on the time that has elapsed from one reward date to a subsequent reward date.

In yet another embodiment of the invention, the reward will not progress linearly but will escalate exponentially over the amount of time the customer remains in the lease agreement. In still another embodiment, the reward escalates exponentially over the amount of time the customer has remained in possession or occupation of a rental property or unit that is the subject of the lease agreement.

In still another embodiment of the invention, the specific value of the reward is calculated based on the number of new customers entering a lease agreement that have been referred to a rental property owner by an existing customer 24.

In still another embodiment of the invention, the reward is based upon the number of new customers occupying or taking possession of a rental property or unit that is the subject of a new lease agreement rather than simply entry into the agreement.

When in operation, a landlord, lessor, or any reward-program administrator, establishes a starting date from which to begin a reward period and at least one reward date on which a reward will be granted 12. The program administrator then confirms that the customer has satisfied the provisions of a lease agreement as of the reward date and then calculates the specific value of the reward to be awarded 14.

In order to facilitate the administration of the reward program, the program administrator may also assign the customer a form of identification and then establish a reward account based on the identification assigned. This account will provide a place for the program administrator to automatically deposit the reward on the reward date.

Depending on how long a customer remains in a lease agreement, the reward program may have more than one reward date. These reward dates may even be a series of dates. In calculating the reward to be awarded on a given reward date, one may have the reward progress linearly over time (i.e., an award of x on the first reward date, 2x on the second reward date, 3x on the third, etc.). Another way of determining the reward, however, is to have the reward increases exponentially over time This can be done, for example, by using the equation

y=e^{x}+n*b+g*h

where:

y=the total number of reward points or units accrued by the customer;

e=the exponential constant 2.7182 . . . ;

x=the number of given time periods the customer has remained in the lease;

n=the number of times the customer has made his lease payments in advance or on time;

b=the number of reward points or units the customer receives for making each lease payment in advance or on time;

g=the number of new customers referred to the rental property owner by an existing customer; and

h=the number of reward points or units the customer receives for introducing each new customer.

As shown in FIGS. 1(A-C), when practicing this embodiment of the invention, once a customer either enters a lease agreement, takes possession of or occupies a rental property unit 10, a reward-program administrator would establish a reward period by identifying a starting date and a reward date 12. The given time period on which the reward is based is a period of time determined by the lessor. This time period—which may be changed from time-to-time by the lessor without departing from the spirit of the invention—may be of any length including, but not limited to, a yearly basis, a half-year basis or a quarterly basis. On the reward date, the program administrator would determine if the provisions of the lease agreement had been performed 14 and if the customer had remained in the lease for the required period of time 16. If they had, the administrator would calculate a reward of a specific value “y” using the formula e^{x} 18.

Once the value of e^{x} has been determined, the administrator would check to see if all the lease payments due during the reward period where paid on time 20. If they were, the administrator would add the value of n*b to the value calculated using e^{x} 22. Therefore, the reward the customer received would have the specific value y=e^{x}+n*b. After checking to see if all lease payments were made on time, the reward plan administrator will determine if the customer has referred any new customers to the rental property owner during the reward period 24. If referrals have been made, the administrator will add the value of g*h to the specific value of the reward 26. Thus, the specific value of the reward “y” would equal e^{x}+n*b+g*h.

Of course, one could use any combination of these various embodiments to calculate a specific value for the reward without departing from the scope of the invention. For example, an administer may base the specific value of the reward only on the length of time a customer remains in the lease and the number of referrals made during that time. Furthermore, the specific value of the reward may be based only on the number of lease payments made on time 18(a), 22(a) or the number of customers referred 24(a)-(d) and 26(a)-(d) should the customer fail to satisfy all the provisions of the lease or fail to remain in the lease the required amount of time.

In another example, the specific value of the reward can be calculated using the equation:

y=e^{x}+(n₁*b₁)+(e¹⁺ⁿ²+n₂+1)

where:

y=the total number of reward points or units accrued by the customer;

e=the exponential constant 2.7182 . . . ;

x=the number of given time periods the customer has remained in the lease;

n₁=the number of times the customer has made his lease payments in advance or on time;

b₁=the number of reward points or units the customer receives for making each lease payment in advance or on time; and

n₂=the number of customers referred to the rental property owner. NOTE: n2 as used in e¹⁺ⁿ² is the same as n₂.

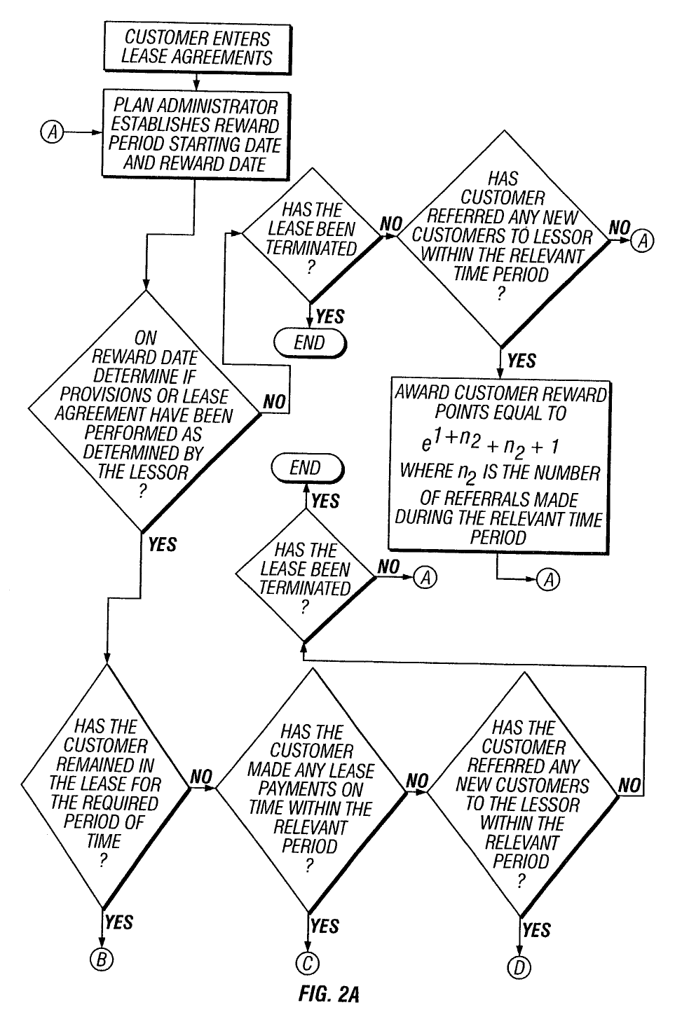

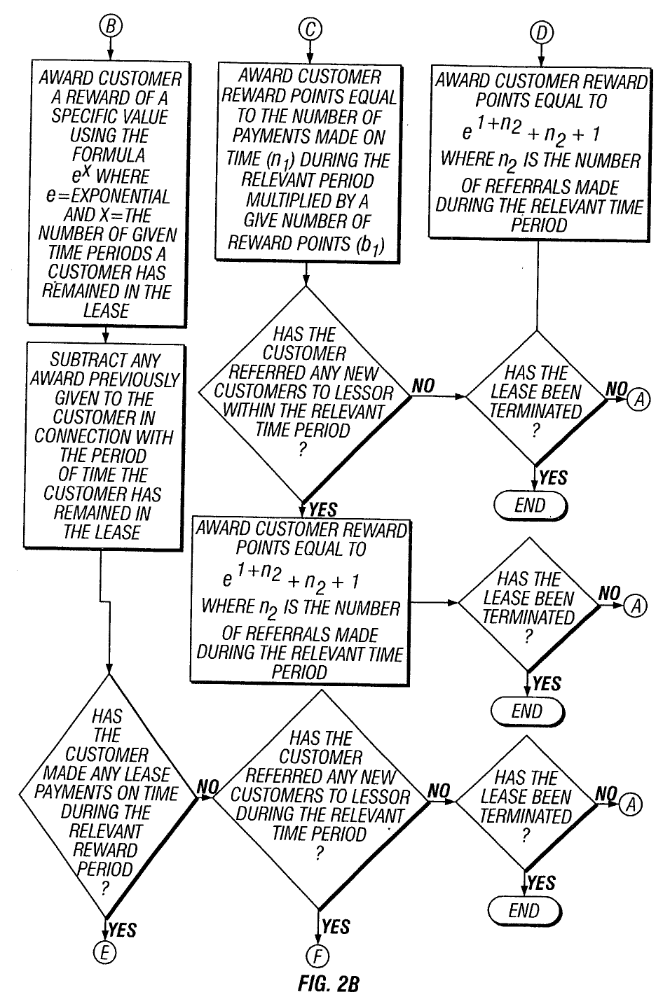

In this example, as shown in FIGS. 2(A-C), the reward may be calculated on a half-year or quarterly basis. For example, if a customer remained in a lease for four years, and assuming the reward date was every six months with all lease payments made on time and 0.1 points were awarded for each on-time payment, the customer could accumulate reward points as follows:

6 months stay and 6 months prompt payment=e^{0.5}+(6×0.1)=2.2487

12 months stay and 12 months prompt payment=e¹+(12×0.1)=3.9183

18 months stay and 18 months prompt payment=e^{1.5}+(18×0.1)=6.2817

24 months stay and 24 months prompt payment=e²+(24×0.1)=9.7891

30 months stay and 30 months prompt payment=e^{2.5}+(30×0.1)=15.1825

36 months stay and 36 months prompt payment=e³+(36×0.1)=23.6855

42 months stay and 42 months prompt payment=e^{3.5}+(42×0.1)=37.3155

48 months stay and 48 months prompt payment=e⁴+(48×0.1)=59.3982

If the customer were to have referred new customers during this time period, he would have been awarded additional reward points as follows:

1 introduction (i.e., n₂=1), additional reward points=e²+2=9.3891

2 introductions (i.e., n₂=2), additional reward points=e³+3=23.0855

3 introduction (i.e., n₂=3), additional reward points=e⁴+4=58.5982

As a result, if a customer remained in a lease for 48 months, made all of his lease payments on time and referred 3 new customers to the lessor, the customer could have accumulated 117.9964 reward points.

Once a customer has accumulated a certain number of reward points, these points may be redeemed for valuable goods and services including, among other things, a package tour or an airline ticket to a particular destination supplied by the lessor.

In still another embodiment of the invention, the specific value of the reward may be calculated using the formula:

y=e^{x}+(n₁*b₁)+(n₂*b₂)

where:

y=the total number of reward points or units awarded to the customer on each reward date;

e=the exponential constant 2.7182 . . . ;

x=0.5 (i.e., the reward is calculated every half year);

n₁=the number of times the customer has made his lease payments in advance or on time during the reward period;

b₁=the number of reward points or units the customer receives for making each lease payment in advance or on time;

n₂=the number of customers referred to the rental property owner; and

b₂=the number of reward points or units the customer receives for each referral.

Using this formula, reward points will be awarded every six months (or any fractional part of a year as may be desired). These reward points can accrue up to a particular time at which point they may be exchanged for some type of gift package. The gift package may include a tour package and air travel to a particular destination. The choice of the destination may vary according to the number or reward points that are being exchanged.

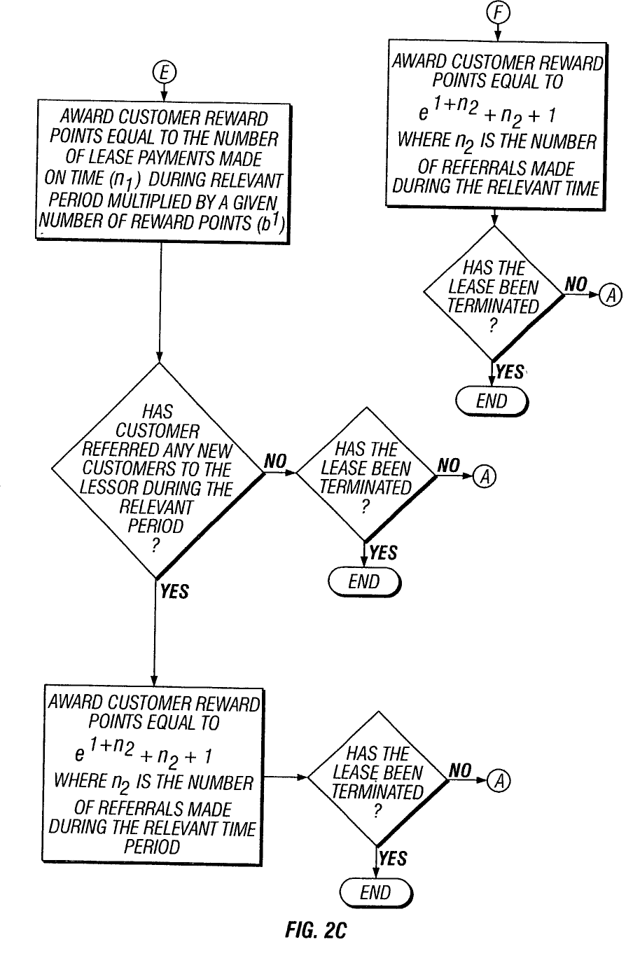

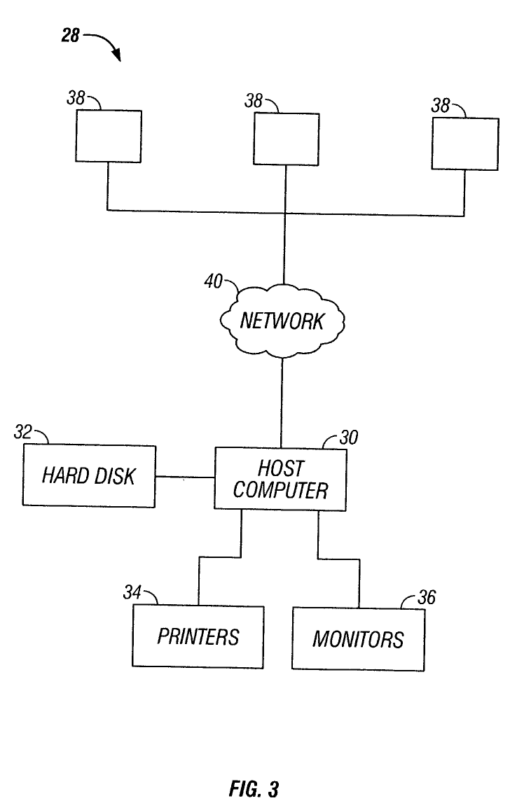

The invention also involves a data processing system 28 for managing a customer-loyalty-reward program with respect to a lease agreement. Referring to FIG. 3, an example of a data processing system 28 is shown. The data processing system in one example includes a plurality of components, such as computer software and/or hardware components 30, 32, 34, 36. A number of such components can be combined or divided as necessary. The system may also interact with remote computers 38 via a network 40.

The system also could include at least one computer-readable medium. Examples of computer-readable mediums include, but are not limited to, magnetic, optical and atomic data storage mediums. The computer-readable medium could also comprise a modulated carrier signal transmitted over a network 40 comprising or coupled with system, for instance, a telephone network, a local area network (LAN), the Internet and/or a wireless network. An exemplary component of system 28 employs and/or comprises a series of computer instructions written in or implemented with any of a number of programming languages, as will be appreciated by those skilled in the art.

The data processing system 28 includes a reward-calculation component for calculating a reward of a specific value based on a starting date and at least one specific reward date. The data processing system may further be comprised of a display device 36 for displaying the calculated reward as well as an output device 34 for generating a print-out of the calculated reward. Although the lease agreement may involve any form of rental property, it is envisioned that in its most common form, the lease agreement will involve real estate.

In one embodiment of the invention, the reward-calculation component of the data processing system calculates the reward based on the number of new customers that have been referred to a rental-property owner by an existing customer. In this embodiment, the reward calculation can be initiated when the new customers either take possession of or occupy the rental property. In another embodiment, the reward-calculation component calculates a series of lease payments in relation to the customer, establishes a series of lease-payment dates at a given interval on which at least one lease payment in the series of lease payments is due, accepts entry of at least one of the lease payments on a date no later than at least one of the lease-payment dates in the series, determines if there is at least one unpaid lease payment due prior to the date of collecting the at least one lease payment and awards a reward of a specific value to the customer if there are no unpaid lease payments prior to the date of collecting the at least one lease payment.

In still another embodiment, the reward-calculation component calculates the specific value of the reward based on an amount of time that has elapsed from the starting date to the at least one reward date. The starting date can be any date including, but not limited to, the date a customer enters the lease agreement or, the date a customer takes possession of or occupies a rental property or unit that is the subject of the lease agreement. Furthermore, the specific value of the reward may also be based on the amount of time that has elapsed from one reward date to a second subsequent reward date.

In addition to calculating the reward based on the amount of time that has elapsed from a starting date to a reward date, the reward-calculation component may, in another embodiment, calculate the specific value of the reward based on the number of new customers that have been referred to a rental-property owner by an existing customer subsequent to the starting date. In a particular version of such embodiment, the specific value of the reward is based on the number of new customers taking possession of or occupying a rental property or unit that is the subject of a lease agreement that have been referred to a rental-property owner by an existing customer subsequent to the starting date.

When in operation, the data processing system allows the customer-reward program to be managed through the use of a computer. Such a system may be viewed locally or via a global network 40 without departing from the scope of the invention.

The invention also involves a computer-readable medium having computer-executable instructions for performing a method comprising: (a) assigning a form of identification to a customer; (b) establishing a reward account for the customer based on the identification assigned; (c) identifying a starting date; (d) determining at least one reward date; (e) calculating a reward of a specific value; and (f) depositing the calculated reward into the customer's reward account.

In another embodiment of the invention, the computer-readable medium has computer-executable instructions for identifying the starting date as either the date on which the customer entered into the lease agreement or, the date on which the customer takes possession of or occupies a rental property or unit that is the subject of the lease agreement.

In still another embodiment of the invention, the computer-executable instructions calculate the specific value of the reward based on the number of new customers that have been referred to a rental-property owner by an existing customer subsequent to the starting date. In a particular version of this embodiment, the specific value of the reward is based on the number of new customers taking possession of or occupying a rental property that is the subject of a lease agreement when those customers have been referred to a rental-property owner by an existing customer subsequent to the starting date.

The computer-readable medium may also include computer-executable instructions for performing a method comprising setting up a series of lease payments in relation to the customer, establishing a series of lease-payment dates at a given interval on which at least one lease payment in the series of lease payments is due, collecting at least one of the lease payments on a date no later than at least one of the lease-payment dates in the series, determining if there is at least one unpaid lease payment due prior to the date of collecting the at least one lease payment and awarding a reward of a specific value to the customer if there is no at least one unpaid lease payment due prior to the date of collecting the at least one lease payment.

Again, the lease agreement may be related to any form of rental property, however, in its most common form will most likely involve real estate.

While the principles of the invention have been shown and described in connection with but a few embodiments, it is to be understood clearly that such embodiments are by way of example and are not limiting.

1. A method for rewarding customer loyalty with respect to a lease agreement, the method comprising the steps of:
identifying a starting date;
establishing at least one reward date;
determining if provisions of the lease agreement have been performed as of the at least one reward date; and
calculating a reward of a specific value.

2. The method of claim 1 wherein the starting date is the date on which a customer entered into the lease agreement.

3. The method of claim 1 wherein the starting date is the date on which the customer occupied a rental unit that is the subject of the lease agreement.

4. The method of claim 1 wherein the specific value of the reward increases exponentially from a first reward date to a second reward date.

5. The method of claim 1 further comprising the steps of:
assigning a form of identification to the customer;
establishing a reward account for the customer based on the identification assigned; and
depositing the calculated reward into the customer's reward account.

6. The method of claim 1 further comprising the steps of:
determining a series of reward dates; and
calculating a series of rewards, each reward in the series being of a specific value based on an amount of time that has elapsed from the starting date to a particular reward date in the series of reward dates.

7. The method of claim 1 wherein the reward is airline frequent-flyer miles.

8. The method of claim 1 further comprising the steps of:
setting up a series of lease payments in relation to the customer;
establishing a series of lease-payment dates at a given interval on which at least one lease payment in the series of lease payments is due;
collecting at least one of the lease payments on a date no later than at least one of the lease-payment dates in the series;
determining if there is at least one unpaid lease payment due prior to the date of collecting the at least one lease payment; and
awarding a reward of a specific value to the customer if there is no at least one unpaid lease payment due prior to the date of collecting the at least one lease payment.

9. The method of claim 1 wherein the lease agreement involves real estate.

10. The method of claim 1 wherein the reward is a discount card that provides discounts at a plurality of merchants.

11. The method of claim 1 wherein the reward date is the same date as the start date.

12. The method of claim 1 wherein the reward escalates over the amount of time the customer remains in the lease agreement.

13. The method of claim 1 wherein the specific value of the reward is calculated based on an amount of time that has elapsed from the starting date to the at least one reward date.

14. The method of claim 1 wherein the specific value of the reward is calculated based on the amount of time that has elapsed from the at least one reward date to a second subsequent reward date.

15. The method of claim 1 wherein the reward escalates over the amount of time the customer has remained in occupation of a rental unit that is the subject of the lease agreement.

16. The method of claim 1 wherein the specific value of the reward is calculated based on the number of new customers entering a lease agreement that have been referred to a rental-property owner by an existing customer.

17. The method of claim 1 wherein the specific value of the reward is calculated based on the number of new customers occupying a rental property that is the subject of a lease agreement that have been referred to a rental-property owner by an existing customer.

24. The data processing system of claim 19 wherein the reward-calculation component:
calculates a series of lease payments in relation to the customer;
establishes a series of lease-payment dates at a given interval on which at least one lease payment in the series of lease payments is due;
accepts entry of at least one of the lease payments on a date no later than at least one of the lease-payment dates in the series;
determines if there is at least one unpaid lease payment due prior to the date of collecting the at least one lease payment; and
awards a reward of a specific value to the customer if there are no unpaid lease payments prior to the date of collecting the at least one lease payment.

25. The data processing system of claim 19 wherein the reward-calculation component calculates the specific value of the reward based on an amount of time that has elapsed from the starting date to the at least one reward date.

26. The data processing system of claim 19 wherein the reward-calculation component calculates the specific value of the reward based on an amount of time that has elapsed from the at least on reward date to a subsequent reward date.

27. The data processing system of claim 19 wherein the reward-calculation component calculates specific value of the reward based on the number of new customers entering a lease agreement that have been referred to a rental-property owner by an existing customer subsequent to the starting date.

28. The data processing system of claim 19 wherein the reward-calculation component calculates the specific value of the reward based on the starting date being the date on which a rental unit that is the subject of the lease agreement is first occupied.

29. The data processing system of claim 19 wherein the reward-calculation component calculates the specific value of the reward based on the number of new customers occupying a rental property that is the subject of a lease agreement that have been referred to a rental-property owner by an existing customer subsequent to the starting date.

30. The data processing system of claim 19 wherein the reward-calculation component calculates a reward that increases exponentially from a first reward date to a second reward date.

31. A computer-readable medium having computer-executable instructions for performing a method comprising:
assigning a form of identification to a customer;
establishing a reward account for the customer based on the identification assigned;
identifying a starting date;
determining at least one reward date;
calculating a reward of a specific value; and
depositing the calculated reward into the customer's reward account.

32. The computer-readable medium of claim 31 wherein the medium has computer-executable instructions for identifying the starting date as the date on which the customer entered into the lease agreement.

33. The computer-readable medium of claim 31 wherein the medium has computer-executable instructions for identifying the starting date as the date on which the customer occupies a rental unit that is the subject of the lease agreement.

34. The computer-readable medium of claim 31 wherein the medium has computer-executable instructions for calculating the specific value of the reward based on the number of new customers entering a lease agreement that have been referred to a rental-property owner by an existing customer subsequent to the starting date.

35. The computer-readable medium of claim 31 wherein the medium has computer-executable instructions for calculating the specific value of the reward based on the number of new customers occupying a rental property that is the subject of a lease agreement that have been referred to a rental-property owner by an existing customer subsequent to the starting date.

36. The computer-readable medium of claim 31 wherein the medium has computer-executable instructions for performing a method comprising:
setting up a series of lease payments in relation to the customer;
establishing a series of lease-payment dates at a given interval on which at least one lease payment in the series of lease payments is due;
collecting at least one of the lease payments on a date no later than at least one of the lease-payment dates in the series;
determining if there is at least one unpaid lease payment due prior to the date of collecting the at least one lease payment; and
awarding a reward of a specific value to the customer if there is no at least one unpaid lease payment due prior to the date of collecting the at least one lease payment.

37. The computer-readable medium of claim 31 wherein the lease agreement involves real estate.

38. The computer-readable medium of claim 31 wherein the medium has computer-executable instructions for calculating the specific value of the reward that increases exponentially from a first reward date to a second reward date.
